(19) United States
(12) Patent Application Publication
(10) Pub. No.: US 2021/0201219 A1
(43) Pub. Date: Jul. 1, 2021

(54) INFORMATION PROCESSING APPARATUS, RISK FORECASTING METHOD, AND PROGRAM

(71) Applicant: NEC Corporation, Tokyo (JP)

(72) Inventor: Junko NAKAGAWA, Tokyo (JP)

(73) Assignee: NEC Corporation, Tokyo (JP)

(21) Appl. No.: 16/756,972

(22) PCT Filed: Oct. 12, 2018
(86) PCT No.: PCT/JP2018/038052

§ 371 Date: Apr. 17, 2020

(30) Foreign Application Priority Data
Oct. 18, 2017 (JP) 2017-202195

(51) Int. Cl. G06Q 10/04; G06K 9/62; G06N 20/00

(52) U.S. Cl. CPC G06Q 10/04; G06K 9/6228; G06N 20/00; G06K 9/6262; G06K 9/6261

(57) ABSTRACT

An information processing apparatus (10) includes a data division unit (110) dividing risk occurrence history data of a target region into training data used for computing a risk value for each of combinations of a distribution function spatially and temporally representing a risk distribution in the target region, a spatial parameter of the distribution function, and a temporal parameter of the distribution function, and evaluation-value computation data used for evaluating a combination of the distribution function, the spatial parameter, and the temporal parameter, a selection unit (120) selecting one combination from combinations of the distribution function, the spatial parameter, and the temporal parameter, based on an evaluation value for each combination computed based on the risk value for each combination based on training data and the evaluation-value computation data, and an output unit (130) outputting a risk forecasting result of the target region, by using the selected one combination.

### TECHNICAL FIELD

The present invention relates to a technique for forecasting a risk that may occur.

### BACKGROUND ART

Exemplary techniques for forecasting risks such as crimes or diseases have been disclosed in, for example, the following patent literatures and non-patent literature.

Patent Document 1 discloses a technique of causing a server to mathematically analyze past crime data, compute the quantitative probability (that is, a forecast) as to where, when and what type of crime will occur, project the forecast onto a target region called box, and propose a police resource deployment plan based on the mathematical analysis. Patent Documents 2 and 3 disclose other techniques of mathematically analyzing data of crimes that occurred in the past, and forecasting and providing a risk in a target region.

Patent Document 4 discloses a technique of providing information useful in replanning the layout of surveillance cameras by determining a surveillance camera having a low frequency of display, based on the frequencies of display and the degrees of increase in display frequency of the surveillance cameras.

Non-Patent Document 1 discloses a technique of analyzing the phenomenon of near repeat victimization for the occurrence of crimes by computing a statistic called a spatio-temporal K function from crime occurrence history data in a certain area. The near repeat victimization for the occurrence of crimes means that in a place near where a certain crime has occurred, another crime repeatedly occurs over a short period of time. Temporally and spatially analyzing the degree of accumulation of occurrences yields information as to the presence or absence of such near repeat victimization, and the spatio-temporal K function is used for this analysis.

### RELATED DOCUMENT

### Patent Document

[Patent Document 1] U.S. Pat. No. 8,949,164
[Patent Document 2] U.S. Pat. No. 9,129,219
[Patent Document 3] U.S. Patent Application Publication No. 2015/0379413
[Patent Document 4] Japanese Patent Application Publication No. 2012-213124

### Non-Patent Document

[Non-Patent Document 1] George Kikuchi, Mamoru Amemiya, Takahito Shimada, Tomonori Saito, and Yutaka Harada, “An Analysis of Near Repeat Victimization Patterns across Crime Types: An Application of Spatio-Temporal K Function,” Theory and Applications of GIS, 2010, Vol. 18, No. 2, pp. 21-30

### SUMMARY OF THE INVENTION

### Technical Problem

In the techniques, as described above, for forecasting a risk that may occur, it is desirable that the forecasting result and an actual observation result (risk occurrence result) agree with each other at a high probability.

The present invention has been made in consideration of the above-described problem. It is one object of the present invention to provide a technique capable of accurately forecasting a risk that may occur.

### Solution to Problem

The present invention provides an information processing apparatus including:

a data division unit that divides risk occurrence history data of a target region into training data used for computing a risk value for each of combinations of a distribution function spatially and temporally representing a risk distribution in the target region, a spatial parameter of the distribution function, and a temporal parameter of the distribution function, and evaluation-value computation data used for evaluating a combination of the distribution function, the spatial parameter, and the temporal parameter;

a selection unit that selects one combination from among combinations of the distribution function, the spatial parameter, and the temporal parameter, based on an evaluation value for each of the combinations computed based on a risk value for each of the combinations based on the training data and the evaluation-value computation data; and

an output unit that outputs a risk forecasting result of the target region, by using the one combination selected by the selection unit.

The present invention provides an information processing apparatus including:

a cell division unit that divides a target region into a plurality of cells;

a generation unit that generates a plurality of combinations of a distribution function spatially and temporally representing a risk distribution in the target region, a spatial parameter of the distribution function, and a temporal parameter of the distribution function;

a selection unit that computes an evaluation value for each of the combinations, by using risk occurrence history data for each of the cells from among risk occurrence history data of the target region, and selecting one combination from among the plurality of combinations, based on the evaluation value for the each combination; and

an output unit that outputs a risk forecasting result of the target region, by using the one combination selected by the selection unit.

The present invention provides a first risk forecasting method executed by a computer, the method including:

dividing risk occurrence history data of a target region into training data used for computing a risk value for each of combinations of a distribution function spatially and temporally representing a risk distribution in the target region, a spatial parameter of the distribution function, and a temporal parameter of the distribution function, and evaluation-value computation data used for evaluating a combination of the distribution function, the spatial parameter, and the temporal parameter;

selecting one combination from among combinations of the distribution function, the spatial parameter, and the temporal parameter, based on an evaluation value for each of the combinations computed based on a risk value for each of the combinations based on the training data and the evaluation-value computation data; and

outputting a risk forecasting result of the target region, by using the selected one combination.

The present invention provides a second risk forecasting method executed by a computer, the method including:

dividing a target region into a plurality of cells;

generating a plurality of combinations of a distribution function spatially and temporally representing a risk distribution in the target region, a spatial parameter of the distribution function, and a temporal parameter of the distribution function;

computing an evaluation value for each of the combinations, by using risk occurrence history data for each of the cells from among risk occurrence history data of the target region, and selecting one combination from among the plurality of combinations, based on the evaluation value for the each combination; and

outputting a risk forecasting result of the target region, by using the selected one combination.

The present invention provides a program for causing a computer to execute the first risk forecasting method.

The present invention provides a program for causing a computer to execute the second risk forecasting method.

### Advantageous Effects of Invention

The present invention provides a technique capable of accurately forecasting a risk that may occur.

### BRIEF DESCRIPTION OF THE DRAWINGS

The above and other objects, features, and advantages will be more apparent from the following description of preferred example embodiments and the following accompanying drawings.

FIG. 1 is a block diagram conceptually depicting the functional configuration of an information processing apparatus according to a first example embodiment.

FIG. 2 is a diagram conceptually depicting the hardware configuration of the information processing apparatus.

FIG. 3 is a table depicting exemplary information stored in a history data storage unit.

FIG. 4 is a flowchart illustrating the sequence of processing by the information processing apparatus according to the first example embodiment.

FIG. 5 is a block diagram conceptually depicting the functional configuration of an information processing apparatus according to a second example embodiment.

FIG. 6 is a flowchart illustrating the sequence of processing by the information processing apparatus according to the second example embodiment.

FIG. 7 is a graph illustrating a kernel function.

FIG. 8 is a diagram depicting an exemplary table that stores combinations of distribution functions, spatial parameters, and temporal parameters.

FIG. 9 is a diagram for explaining the sequence of extracting training data by a selection unit.

FIG. 10 is a table for explaining the sequence of computing a sum of risk value relative rank.

FIG. 11 is a diagram depicting an exemplary table that stores an evaluation value for each combination.

FIG. 12 is a diagram depicting an exemplary table that stores optimum combinations of distribution functions, spatial parameters, and temporal parameters.

FIG. 13 is a block diagram conceptually depicting the functional configuration of an information processing apparatus according to a third example embodiment.

FIG. 14 is a flowchart illustrating the sequence of processing by the information processing apparatus according to the third example embodiment.

FIG. 15 is a diagram depicting an exemplary table that stores an evaluation value for each combination.

FIG. 16 is a diagram depicting an exemplary table that stores optimum combinations of distribution functions, spatial parameters, and temporal parameters.

### DESCRIPTION OF EMBODIMENTS

Example embodiments of the present invention will be described below with reference to the drawings. It should be noted that in all the drawings, the same reference numerals denote the same components, and a description thereof will not be repeated as appropriate. Unless otherwise specified, in each block diagram, the blocks do not represent hardware-specific configurations, but represent function-specific configurations.

[Description of Overview]

An information processing apparatus according to the present invention uses history data of risks that occurred in the past (to be referred to as “risk occurrence history data” hereinafter) to determine an optimum combination among combinations of distribution functions spatially and temporally representing the distributions of the risks, and spatial parameters and temporal parameters used in the distribution functions. In this specification, the “optimum combination” means a combination exhibiting a risk forecasting accuracy rate higher than those of other combinations. The “risks” in this specification are not particularly limited, but they include, for example, crimes, diseases, infectious diseases (for example, influenza), disease injuries due, for example, to communicable diseases damaging livestock or crops, pests, and natural disasters such as earthquakes and typhoons. The case where “crimes” are handled among these “risks” will be mainly taken as an example in the following example embodiments.

### First Example Embodiment

{Functional Configuration}

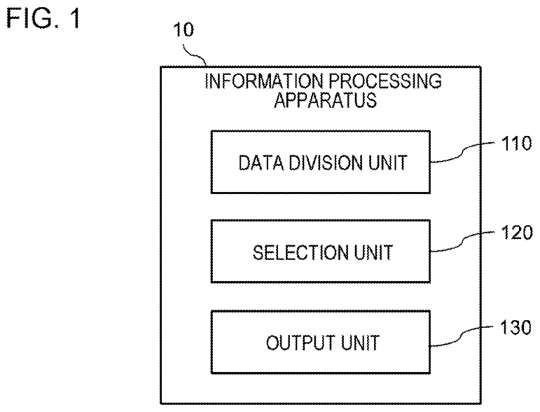

FIG. 1 is a block diagram conceptually depicting the functional configuration of an information processing apparatus 10 according to a first example embodiment. The information processing apparatus 10 according to this example embodiment includes a data division unit 110, a selection unit 120, and an output unit 130, as depicted in FIG. 1.

The data division unit 110 divides risk occurrence history data of a target region into data (to be referred to as “training data” hereinafter) used to compute a risk value for each combination of a distribution function, a spatial parameter, and a temporal parameter, and data (to be referred to as evaluation-value computation data) hereinafter) used to evaluate this combination. The risk value means herein a value representing whether the probability that a risk will occur is high or low, and can take values in an arbitrary range. The selection unit 120 computes an evaluation value for each combination, based on the risk value for each combination based on the training data and the evaluation-value computation data. The selection unit 120 selects one optimum combination from the plurality of combinations of the distribution functions, the spatial parameters, and the temporal parameters, based on the computed evaluation value for each combination. The output unit 130 forecasts a risk in the target region, using the combination selected by the selection unit 120, and outputs the forecasting result.

{Hardware Configuration}

Each functional configuration unit of the information processing apparatus 10 may be implemented as hardware (for example, a hard-wired electronic circuit) for implementing this functional configuration unit, or may be implemented as a combination of hardware and software (for example, a combination of an electronic circuit and a program for controlling it). The case where each functional configuration unit of the information processing apparatus 10 is implemented as a combination of hardware and software will further be described below.

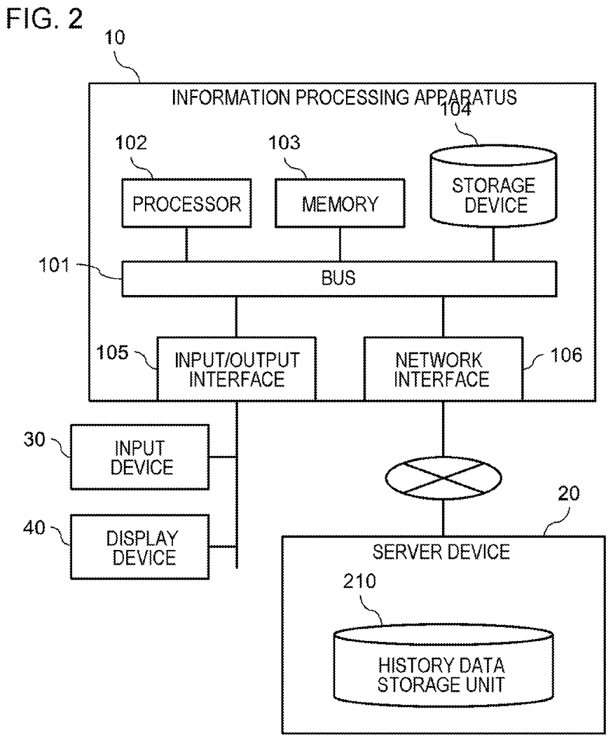

FIG. 2 is a diagram conceptually depicting the hardware configuration of the information processing apparatus 10. The information processing apparatus 10 includes a bus 101, a processor 102, a memory 103, a storage device 104, an input/output interface 105, and a network interface 106, as depicted in FIG. 2.

The bus 101 serves as a data transmission line for allowing the processor 102, the memory 103, the storage device 104, the input/output interface 105, and the network interface 106 to exchange data with each other. The method for connecting, for example, the processor 102, the memory 103, the storage device 104, the input/output interface 105, and the network interface 106 to each other, however, is not limited to bus connection.

The processor 102 serves as an arithmetic unit such as a central processing unit (CPU) or a graphics processing unit (GPU). The memory 103 serves as a main storage implemented using, for example, a random access memory (RAM) or a read only memory (ROM). The storage device 104 serves as an auxiliary storage implemented using, for example, a hard disk drive (HDD), a solid state drive (SSD), or a memory card.

The storage device 104 stores a program module for implementing each functional configuration unit (the data division unit 110, the selection unit 120, and the output unit 130) of the information processing apparatus 10. The processor 102 implements a function corresponding to each program module by reading the program module into the memory 103 and executing it.

The input/output interface 105 is used to connect the information processing apparatus 10 to peripheral equipment. An input device 30 and a display device 40, for example, are connected to the input/output interface 105. The input device 30 serves as a device for input, such as a keyboard or a mouse. The display device 40 serves as a device for display output, such as a liquid crystal display (LCD) or a cathode ray tube (CRT) display.

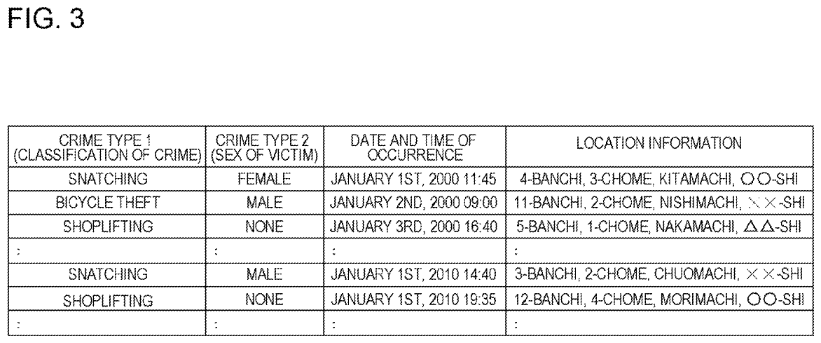

The network interface 106 is used to connect the information processing apparatus 10 to a communication network such as a local area network (LAN) or a wide area network (WAN). It should be noted that the method for connection to the communication network may be either wireless or wired connection. An external device 20 including a history data storage unit 210 that stores risk occurrence history data, for example, may be connected to the network interface 106. The history data storage unit 210 may even be provided in the information processing apparatus 10. The history data storage unit 210 accumulates data representing the occurrence history of risks (see, for example, FIG. 3). FIG. 3 is a table depicting exemplary information stored in the history data storage unit 210. In the example illustrated in FIG. 3, the history data storage unit 210 stores data containing the crime type, the date and time of the occurrence of the crime, and the occurrence location of the crime. It should be noted that the crime type may be classified into a category such as the classification of a crime (for example, snatching, bicycle theft, or shoplifting) or the attribute of a victim (for example, his or her sex or age), as depicted in FIG. 3.

{Operation Example}

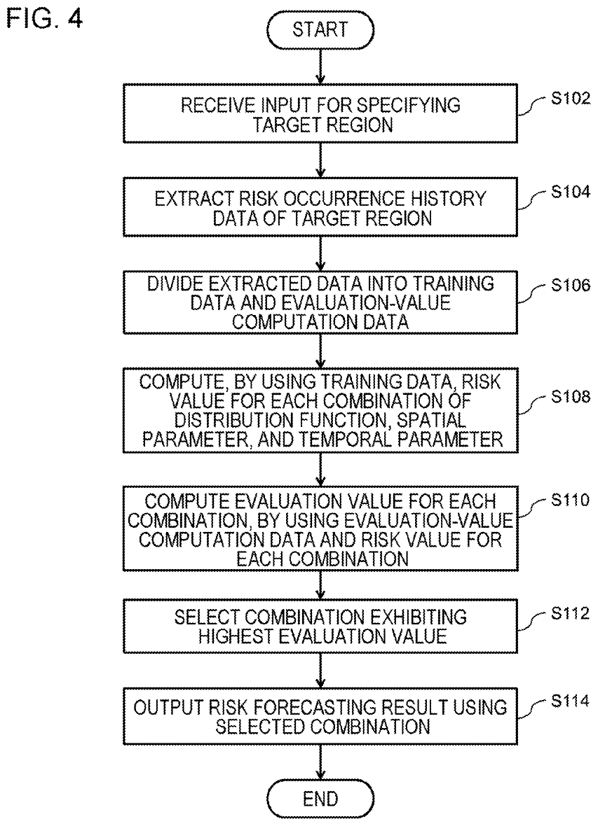

An operation example of the information processing apparatus 10 according to the first example embodiment will be described below with reference to FIG. 4. FIG. 4 is a flowchart illustrating the sequence of processing by the information processing apparatus 10 according to the first example embodiment.

The data division unit 110, for example, receives, via the input device 30, input for specifying a target region by the operator of the information processing apparatus 10 (S102). Data of the target region specified in the process of step S102 is extracted from the risk occurrence history data stored in the history data storage unit 210 (S104). It should be noted that the data division unit 110 may further receive input for specifying a period and extract data in the specified period as a target. The data division unit 110 divides the extracted data into training data and evaluation-value computation data (S106). As an example, the data division unit 110 can divide the extracted data into training data and evaluation-value computation data in the following way. The data division unit 110 first sets a sample time instant in the specified period. The data division unit 110 then determines a point of time earlier than the sample time instant, based on a temporal parameter, and sets, as training data, data included in a period defined between the sample time instant and the earlier point of time. The data division unit 110 further sets, as evaluation-value computation data, data included in a predetermined evaluation period after the sample time instant. It should be noted that the data division unit 110 may set a plurality of sample time instants in the specified period and set training data and evaluation-value computation data for each of the plurality of sample time instants. Setting a plurality of sample time instants generates a plurality of combinations of training data and evaluation-value computation data. Computing evaluation values using the plurality of combinations improves the reliability of the evaluation values.

The selection unit 120 computes a risk value using the training data, for each combination of a distribution function, a spatial parameter, and a temporal parameter (S108). It should be noted that a plurality of combinations of distribution functions, spatial parameters, and temporal parameters may be stored in a predetermined storage (for example, the memory 103 or the storage device 104) in advance. The selection unit 120 may even generate a plurality of combinations of distribution functions, spatial parameters, and temporal parameters in accordance with a predetermined rule. The selection unit 120 computes an evaluation value for each combination, based on the risk value for each combination computed for each combination using the training data and the evaluation-value computation data (S110). As an example, the selection unit 120 can compute a numerical value indicating the degree of association of the risk value computed for each combination with an actual risk occurrence count, based on the risk value for each combination computed using the training data for each sample time instant, and the risk occurrence count in the evaluation period corresponding to each sample time instant (the number of pieces of evaluation-value computation data for each sample time instant). The selection unit 120 selects a combination exhibiting a highest evaluation value, based on the computed evaluation value for each combination (S112).

The output unit 130 computes a risk distribution at a future point of time using a combination of a distribution function, a spatial parameter, and a temporal parameter, selected for the target region, and outputs it to the display device 40 or the like as a forecasting result (S114). The output unit 130 outputs, for example, a map representing the forecasting result of the risk distribution to the display device 40 or the like. The output unit 130 may even output a map representing the forecasting result of the risk distribution to a printing device (not illustrated). In this case, the map representing the forecasting result of the risk distribution is output from the printing device (not illustrated).

It should be noted that the processes in step S112, in which an optimum combination of a distribution function and a set of parameters involved is selected, and the preceding steps, and the process in step S114 in which a risk is forecasted using the selected combination need not always be performed successively.

As described above, in this example embodiment, history data of risks that occurred in the past are used to evaluate, for each combination of a distribution function and parameters of the distribution function, whether the forecasting accuracy rate of the combination for the risks is high. A most highly evaluated combination (that is, a combination exhibiting a high accuracy rate in risk forecasting) is selected from the plurality of combinations. Forecasting risks in a target region using the thus selected combination makes it possible to accurately forecast a risk that may occur in the target region. With the increased accuracy in forecasting, furthermore, a person engaged in risk management can easily devise an effective measure.

### Second Example Embodiment

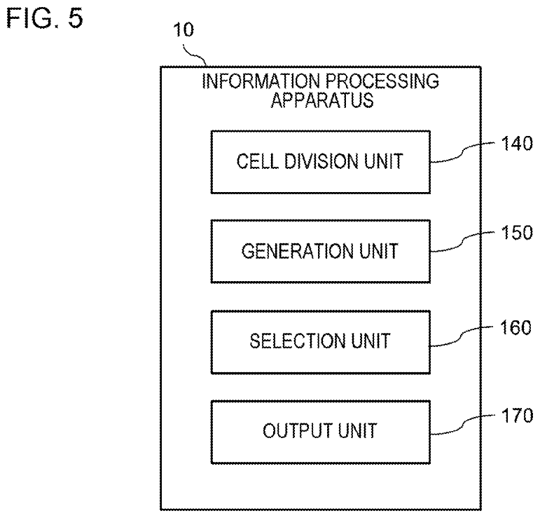

{Functional Configuration}FIG. 5 is a block diagram conceptually depicting the functional configuration of an information processing apparatus 10 according to a second example embodiment. The information processing apparatus 10 according to this example embodiment includes a cell division unit 140, a generation unit 150, a selection unit 160, and an output unit 170.

The cell division unit 140 receives input of information for specifying a target region and divides the target region into a plurality of subareas (to be referred to as “cells” hereinafter). The generation unit 150 generates a plurality of combinations of distribution functions spatially and temporally representing the risk distributions in the target region, spatial parameters of the distribution functions, and temporal parameters of the distribution functions. The selection unit 160 computes an evaluation value for each combination of the distribution function, the spatial parameter, and the temporal parameter, generated by the generation unit 150, using risk occurrence history data for each cell among risk occurrence history data of the target region. The selection unit 160 selects one combination from the plurality of combinations of the distribution functions, the spatial parameters, and the temporal parameters, based on the computed evaluation value for each combination. More specifically, the selection unit 160 selects a combination exhibiting a highest evaluation value. The output unit 170 outputs a risk forecasting result of the target region, using the combination of the distribution function, the spatial parameter, and the temporal parameter, selected by the selection unit 160, similarly to the first example embodiment.

{Hardware Configuration}

The hardware configuration according to this example embodiment is similar to that (see, for example, FIG. 2) according to the first example embodiment. The storage device 104 according to this example embodiment stores program modules for respectively implementing the functions of the cell division unit 140, the generation unit 150, the selection unit 160, and the output unit 170. The functions of the cell division unit 140, the generation unit 150, the selection unit 160, and the output unit 170 are implemented by the processor 102 of the information processing apparatus 10 executing these program modules.

{Operation Example}

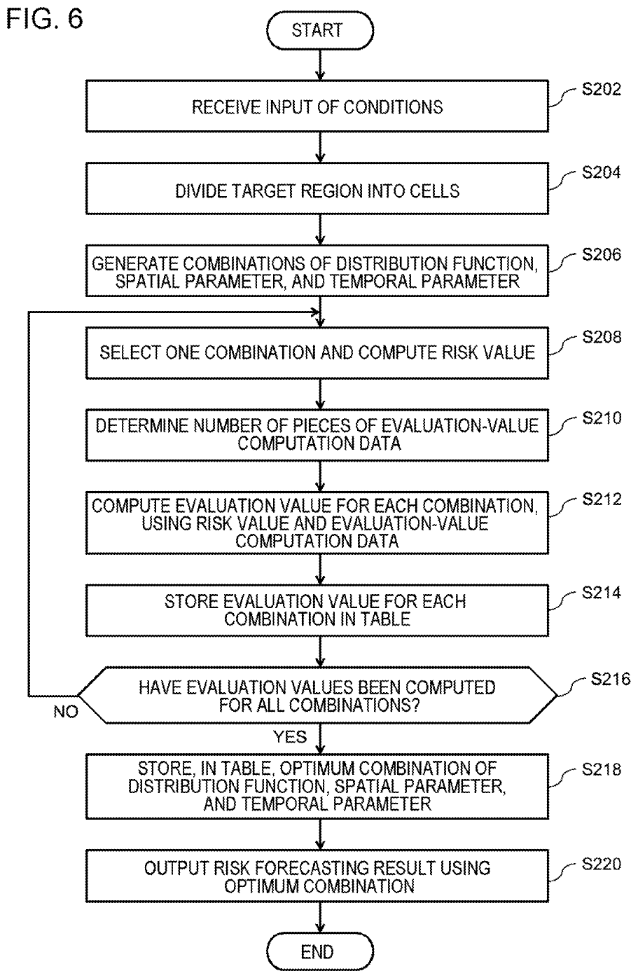

An operation example of the information processing apparatus 10 according to the second example embodiment will be described below with reference to FIG. 6. FIG. 6 is a flowchart illustrating the sequence of processing by the information processing apparatus 10 according to the second example embodiment. An example of a process assuming a “crime” as the risk will be given herein.

The information processing apparatus 10 first receives input of conditions for selecting an optimum combination of a distribution function and a set of parameters involved (S202). As an example, the information processing apparatus 10 receives input for specifying a target region and a training period (a period to which data used in evaluation for each combination belong). The information processing apparatus 10 may further include a reception unit (not illustrated) that receives a crime type (for example, the classification of a crime, the sex/age of a crime victim, or a combination of them) as one of the above-mentioned conditions. In addition, the information processing apparatus 10 acquires a risk distribution function. The risk distribution function has been stored in, for example, the memory 103, the storage device 104, or an external storage (not illustrated).

The risk distribution function can be defined herein using, for example, the following equation (1):

$$\begin{matrix}[ Math 1 ] & \\ R ( g , k ) = \frac{1}{{h}_{s}^{2} {h}_{t}} {\sum }_{i = 1}^{{I}^{k}} {K}_{s} [ \frac{{x}_{g} - {x}_{i}}{{h}_{s}} , \frac{{y}_{g} - {y}_{i}}{{h}_{s}} ] {K}_{t} [ \frac{{t}^{k} - {t}_{i}}{{h}_{t}} ] & ( 1 )\end{matrix}$$

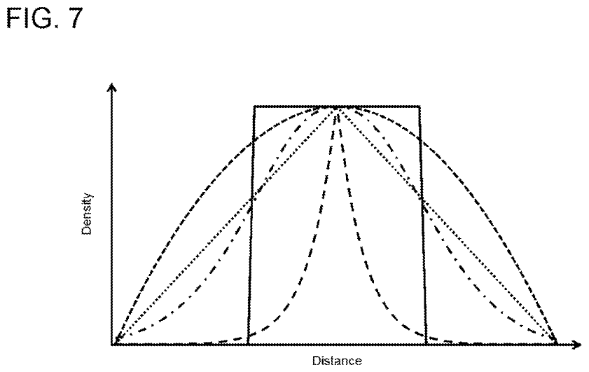

In the equation (1) above, R(g, k) denotes the “risk value of the cell g at the time instant t^{k}”. In the equation (1) above, hₛ is the space bandwidth (spatial parameter) and hₜ is the time bandwidth (temporal parameter). In the equation (1) above, I^{k} is the number of pieces of crime occurrence history data used to compute the risk value. i is the label number assigned to each piece of crime occurrence history data used to compute the risk value. In the equation (1) above, Kₛ and Kₜ describe the shapes of kernel functions for determining the spatial and temporal spreads, respectively, in the distribution function. The kernel functions to be set for Kₛ and Kₜ can be selected from kernel functions having various shapes as illustrated in, for example, FIG. 7. FIG. 7 illustrates kernel functions having five shapes: uniform (solid line), triangular (dotted line), quartic (short broken line), normal (alternate long and short dashed line), and negative exponential (long broken line). It should be noted that FIG. 7 illustrates merely an example, and the kernel functions are not limited to the shapes depicted in FIG. 7. The kernel functions to be set for Kₛ and Kₜ may have either the same shape or different shapes. In the example illustrated in FIG. 7, 25 combinations are obtained as the combinations of the kernel functions for the above-mentioned equation (1). It should be noted that the parameter used in the distribution function may be one of the spatial parameter and the temporal parameter. For example, the definition of the distribution function indicating that the risk distribution of the target region varies between Sunday and holidays, and the remaining days of the week does not include the spatial parameter, but includes the temporal parameter. The distribution function may even be defined by the sum of a plurality of terms, and a coefficient representing the ratio of each term may be set as the parameter. For example, two kernel functions may be selected from the kernel functions depicted in FIG. 7, and the sum of the products of the respective kernel functions multiplied by individual coefficients may be set as the distribution function. Even in this case, an optimum combination can be selected by the method according to each example embodiment.

The following equation (2) gives a specific example in which the above-mentioned equation (1) is combined with kernel functions. It should be noted that in the following equation (2), x_{g} and y_{g} are the position coordinates of the cell g (for example, the position coordinates of the central point of the cell) in a space defined by x- and y-axes orthogonal to each other; xᵢ and yᵢ are the position coordinates of a crime contained in the ith labeled crime occurrence history data in the space defined by the orthogonal x- and y-axes; and tᵢ is the date and time of the occurrence of the crime contained in the ith labeled crime occurrence history data.

$$\begin{matrix} [ Math 2 ] & \\ R ( g , k ) = \frac{1}{{h}_{s}^{2} {h}_{t}} {\sum }_{i = 1}^{{I}^{k}} {( 1 + \frac{1}{{h}_{s}} \sqrt{{( {x}_{g} - {x}_{i} )}^{2} + {( {y}_{g} - {y}_{i} )}^{2}} )}^{- 1} \times {( 1 + \frac{1}{{h}_{t}} ( {t}^{k} - {t}_{i} ) )}^{- 1} & ( 2 )\end{matrix}$$

The above-mentioned equation (2) reveals that the smaller the distance between the position coordinates (x_{g}, y_{g}) of the cell g and the position coordinates (xᵢ, yᵢ) of the ith labeled crime occurrence history data, the higher the risk value of the cell g, while the larger this distance, the lower the risk value of the cell g. The above-mentioned equation (2) also reveals that the closer the time instant t^{k} and the date and time tᵢ of the occurrence of the ith labeled crime occurrence history data are to each other, the higher the risk value of the cell g, while the farther the time instant t^{k} and the date and time tᵢ of the occurrence of the ith labeled crime occurrence history data are from each other, the lower the risk value of the cell g. A risk distribution is obtained for the target region by computing risk values for all the cells using an equation as illustrated above.

The cell division unit 140 divides the specified target region into a plurality of cells (S204). The cell division unit 140 can freely set the shapes and sizes of the cells, based on a predetermined rule or input from the operator of the information processing apparatus 10. As an example, the cell division unit 140 can, upon defining as Δs the length of a short side of a quadrangle enclosing the target region, set, as a unit cell, a square having 1/100 of this Δs as the length of its one side. The cell division unit 140 divides the target region by determining the position, in the target region, of each unit cell without any overlap between the unit cells, and assigning a label g (information for distinguishing the cells from each other) to each unit cell.

The generation unit 150 generates a plurality of combinations of distribution functions and sets of parameters involved (S206). The generation unit 150 can generate a plurality of combinations of distribution functions and sets of parameters involved in, for example, the following way.

The generation unit 150 first sets a plurality of sample time instants t^{k} (k=1, 2, 3, . . . , K) in the specified period. The number K of sample time instants may be automatically determined by the generation unit 150, or may be freely set by input of the operator. When, as a specific example, the period from January 1st, 2000 00:00 to Dec. 31, 2000 23:59 is specified, the generation unit 150 can set the sample time instant t^{k} every four days, which is obtained by rounding off 1/100 of this period (366 days) to the nearest integer. In this case, the sample time instant t^{k} is “t¹=Jan. 1, 2000 00:00, t²=Jan. 5, 2000 00:00, . . . , t^{K}=Dec. 30, 2000 00:00,” and the number K of sample time instants is 92.

The generation unit 150 then determines a period (evaluation period Δt) for computing the criminal event count for each sample time instant. For example, the generation unit 150 first determines crime occurrence data for the crime type and the target region specified in the process of step S202, based on the crime type and the location information of the crime occurrence history data stored in the history data storage unit 210. The generation unit 150 can then set, as the evaluation period Δt, the average of occurrence intervals computed based on the date and time of the occurrence of the determined crime occurrence data. More specifically, when a crime of the specified type occurs every three days on average in the target region, the generation unit 150 can set Δt to three days. It should be noted that the evaluation period may even take a value that varies for each sample time instant.

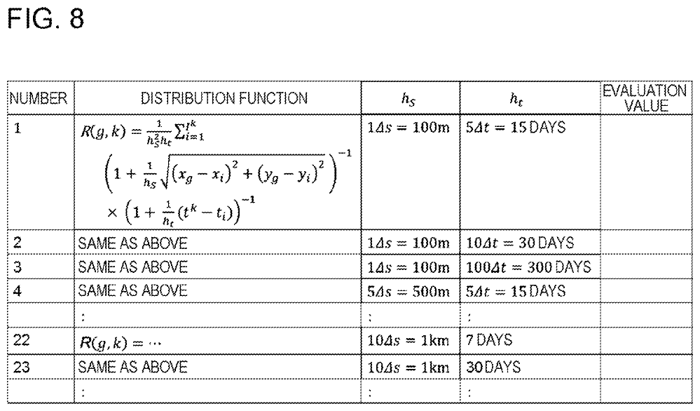

The generation unit 150 can set, for example, as the spatial parameter hₛ a constant multiple (for example, 1, 5, or 10 times) of the length Δs of one side of the unit cell set by the cell division unit 140, and as the temporal parameter hₜ a constant multiple (for example, 5, 10, or 100 times) of the evaluation period Δt. The generation unit 150 sets the spatial parameter hₛ and the temporal parameter hₜ for each of a plurality of distribution functions stored in, for example, the memory 103, the storage device 104, or another storage (not illustrated) in advance, and generates a table as illustrated in, for example, FIG. 8. FIG. 8 is a diagram depicting an exemplary table that stores combinations of distribution functions, spatial parameters, and temporal parameters. The table associates the spatial parameter hₛ and the temporal parameter hₜ with the risk distribution function (the above-mentioned equation (2) or the like) and stores them, as illustrated in FIG. 8.

The generation unit 150 can even generate a combination of a distribution function and a set of parameters involved, based on the technique disclosed in Non-Patent Document 1. Non-Patent Document 1 discloses a technique for analyzing the phenomenon of near repeat victimization for the occurrence of crimes by computing a statistic called a spatio-temporal K function from crime occurrence history data in a certain area. The near repeat victimization for the occurrence of crimes means that when a crime occurs in a certain place, another crime repeatedly occurs in a place near the former place over a short period of time. Temporally and spatially analyzing the degree of accumulation of crimes that have occurred yields information as to the presence or absence of such near repeat victimization. In Non-Patent Document 1, the spatio-temporal K function is used for this analysis. The value (to be referred to as “D₀” hereinafter) obtained by computing the spatio-temporal K function in Non-Patent Document 1 from the crime occurrence history data represents the degree and range in which crimes that have occurred accumulate temporally and spatially. In other words, D₀ represents the temporal and spatial distribution of crime occurrences. The generation unit 150 can use this D₀ as a risk distribution function. It should be noted that in Non-Patent Document 1, D₀ is computed by specifying the “distance zone and distance range from the occurrence place” as the spatial parameter, and the “time span and time range from the date and time of occurrence” as the temporal parameter. The generation unit 150 can generate a combination of a distribution function and a set of parameters involved by setting, for example, the “length Δs of one side of the unit cell” as the “distance zone,” the “length of a short side of the target region” as the “distance range,” the above-mentioned “evaluation period Δt” as the “time span,”, “one year” as the “time range,”, and the like and computing D₀ by the method disclosed in Non-Patent Document 1.

The selection unit 160 selects one combination from a plurality of combinations of distribution functions, spatial parameters, and temporal parameters, stored in a table as illustrated in FIG. 8, and computes a risk value for the selected combination (S208). The selection unit 160 can compute a risk value in, for example, the following way. The selection unit 160 first extracts, from the history data storage unit 210, crime occurrence history data (to be also referred to as “training data” hereinafter) satisfying conditions presented in the following set of inequalities (3), based on the sample time instant t^{k} (k=1, 2, 3, . . . , K), and the spatial parameter hₛ and the temporal parameter hₜ of the selected combination. It should be noted that, when the reception unit (not illustrated) has received input for specifying a crime type (the classification of a risk), the selection unit 160 can identify data corresponding to the crime type (the classification of the risk) specified by this input for specifying. Upon defining as I^{k} the number of pieces of training data extracted for the sample time instants t^{k} (k=1, 2, 3, . . . , K), the selection unit 160 assigns a label i (i=1, 2, 3, . . . , I^{k}) to each of the I^{k} pieces of training data.

[Math 3]

t^{k}−hₜ≤Date and Time of Occurrence<t^{k}

and

\sqrt{(x_{g}−xᵢ)²+(y_{g}−yᵢ)²}≤hₛ (3)

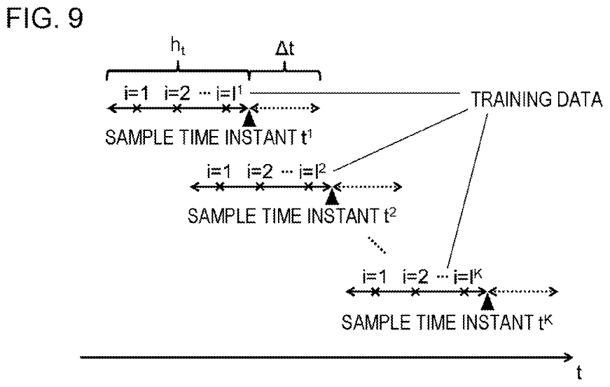

The above-mentioned sequence will be described below with reference to FIG. 9. FIG. 9 is a diagram for explaining the sequence of extracting training data by the selection unit 160. Referring to FIG. 9, the cross marks indicate crime occurrence history data satisfying the above-mentioned set of inequalities (3). The selection unit 160 extracts, as training data, the crime occurrence history data indicated by the cross mark for each sample time instant t^{k} (t¹, t², . . . , t^{K}). At, for example, the sample time instant t, I¹ pieces of training data assigned with I¹ labels from i=1 are extracted by the selection unit 160. As indicated by dotted arrows, an evaluation period Δt is set for each sample time instant, and the selection unit 160 uses crime history data in the evaluation period Δt as evaluation-value computation data (to be described later).

The selection unit 160 computes risk values for all the cells, for the respective sample time instants t¹, t², . . . , t^{K}, using the combination of the distribution function, the spatial parameter, and the temporal parameter selected in the process of step S208, and the I^{k} pieces of training data respectively extracted for the sample time instants t¹, t², . . . , t^{K}. The case where the combination in the first row of the table depicted in FIG. 8 is selected will be considered below as an example. In this case, the selection unit 160 substitutes hₛ=100 m, hₜ=15 days, the position coordinates (xᵢ, yᵢ) of the I^{k} pieces of training data respectively extracted for the sample time instants t¹, t², . . . , t^{K}, and the I^{k} date and times tⁱ of occurrence into the distribution function presented in the above-mentioned equation (2). This yields a risk value R(g, k) for each cell distinguished by the label g (g=1, 2, 3, . . . , G, where G is the total number of cells) for each of the sample time instants t¹, t², . . . , t^{K}. The selection unit 160 computes, as a risk value for the combination, the product of the risk value R(g, k) for each sample time instant and each cell multiplied by the area Δs² of the unit cell and the evaluation period Δt for each sample time instant, as per the following equation (4):

[Math 4]

NR_{g}^{k}=R(g,k)×Δs²Δt (4)

The selection unit 160 extracts crime occurrence history data (to be also referred to as “evaluation-value computation data” hereinafter) corresponding to crimes that have occurred in the evaluation period Δt for each of the sample time instants t¹, t², . . . , t^{K}, from the history data storage unit 210 as evaluation-value computation data, and determines the number of pieces of evaluation-value computation data (S210). More specifically, the selection unit 160 extracts, as evaluation-value computation data, crime occurrence history data satisfying “t^{k}≤Date and Time of Occurrence<t^{k}+Δt” from the crime occurrence history data of the target region stored in the history data storage unit 210. The selection unit 160 computes the criminal event count for each cell for the sample time instant t^{k} by computing the total number of pieces of evaluation-value computation data for each cell, based on the location information of the extracted evaluation-value computation data. The criminal event count for the cell g for the sample time instant t^{k} is mathematically given by the following expression:

[Math 5]

Neval_{g}^{k} (5)

The selection unit 160 computes an evaluation value for each combination, based on the risk value for each cell in each combination, computed as the above-mentioned equation (4), and the criminal event count for each cell for the sample time instant t^{k} computed as the above-mentioned expression (5) (S212).

### Specific Example 1 of Evaluation Value

As an example, the selection unit 160 can compute a coefficient of correlation CORR(hₛ, hₜ) using the following equation (6):

$$\begin{matrix}[ Math 6 ] & \\ CORR ( {h}_{s} , {h}_{t} ) = \frac{〈 ( N {R}_{g}^{k} - 〈 {NR}_{g}^{k} 〉 ) ( N e v a {l}_{g}^{k} - 〈 {Neval}_{g}^{k} 〉 ) 〉}{\sqrt{〈 {( N {R}_{g}^{k} - 〈 {NR}_{g}^{k} 〉 )}^{2} 〉 〈 {( {Neval}_{g}^{k} - 〈 N e ν a {l}_{g}^{k} 〉 )}^{2} 〉}} & ( 6 )\end{matrix}$$

where the pairs of marks < > denote the expected values for all the sample time instants t^{k} and in all the cells distinguished by the labels g. The portions expressed using the pairs of marks < > can be substituted as, for example, the following equation (7):

$$\begin{matrix}[ Math 7 ] & \\ 〈 N e v a {l}_{g}^{k} 〉 = \frac{{\sum }_{k = 1}^{K} {\sum }_{g = 1}^{G} {Neval}_{g}^{k}}{K \times G} & ( 7 )\end{matrix}$$

The coefficient of correlation CORR(hₛ, hₜ) represents the strength of association between the risk value computed using the combination of the distribution function, the spatial parameter, and the temporal parameter, and the criminal event count. The closer the absolute value of the coefficient of correlation CORR(hₛ, hₜ) comes to one, the higher the strength of association between these numerical values. When, for example, the coefficient of correlation CORR(hₛ, hₜ) takes a positive value close to one, a crime can be estimated to occur at a higher probability in a cell exhibiting a higher risk value computed by the selected combination of the distribution function, the spatial parameter, and the temporal parameter.

### Specific Example 2 of Evaluation Value

As another example, the selection unit 160 may compute a sum of risk value relative rank as an index different from the coefficient of correlation. The selection unit 160 can compute the sum of risk value relative rank in, for example, the following way. The selection unit 160 first ranks each cell, based on the risk value for each cell computed using the combination of the distribution function, the spatial parameter, and the temporal parameter, and training data satisfying the conditions presented in the above-mentioned set of inequalities (3) for a certain sample time instant. The selection unit 160, for example, ranks the cells in ascending order as first, second, . . . from cells exhibiting higher computed risk values. The selection unit 160 determines a cell corresponding to each piece of evaluation-value computation data (that is, a cell in which a crime indicated by this piece of evaluation-value computation data has occurred), based on the location information of this piece of evaluation-value computation data, and adds a value that depends on the rank of the determined cell to the sum of risk value relative rank. The selection unit 160 computes the sum of risk value relative rank by repeating the above-mentioned processes for all the sample time instants (t¹, t², t³, . . . , t^{K}). The sum of risk value relative rank may be given by, for example, the following expression (8):

$$\begin{matrix}[ Math 8 ] & \\ {{\sum }_{k = 1}}^{K} {\sum }_{g = 1}^{G} {Neval}_{g}^{k} \times Ran {k}_{g}^{k} \\ for \\ Ran {k}_{g}^{k} = \frac{\begin{matrix}( Rank of Risk Value R ( g , k ) of Cell \\ g at Sample Time Instant {t}^{k} )\end{matrix}}{( Total Number G of Cells )} & ( 8 )\end{matrix}$$

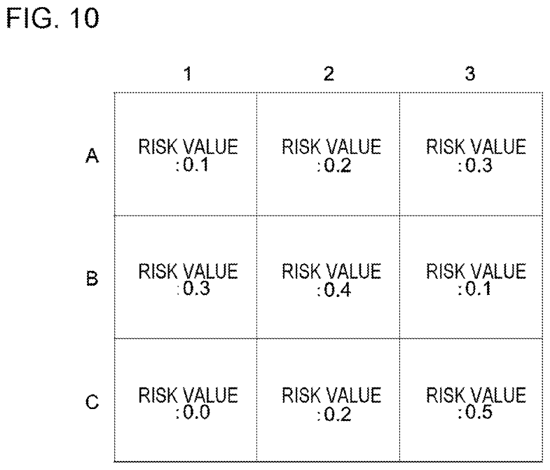

The case where a result as illustrated in FIG. 10 is obtained as the risk value for each cell, using the combination of the distribution function, the spatial parameter, and the temporal parameter, and training data satisfying the conditions presented in the above-mentioned set of inequalities (3) for a certain sample time instant, will be considered below as a specific example. In this case, the selection unit 160 can rank nine cells in the order of, for example, (1) cell C3, (2) cell B2, (3) cells A3 and B1, (4) cells A2 and C2, (5) cells A1 and B3, and (6) cell C1. The selection unit 160 identifies a cell in which a crime indicated by evaluation-value computation data extracted in the evaluation period Δt for the above-mentioned sample time instant has occurred, based on the location information of the evaluation-value computation data. The selection unit 160, for example, adds the value of “(Rank of Cell in Question)/(Total Number of Cells)” to the risk value for each combination. More specifically, when the location of a crime that has occurred in the evaluation period Δt corresponds to cell C3, “(Rank of Cell C3)/(Total Number of Cells)=1/9” is added to the risk value for each combination. An evaluation value obtained as a result of repeating the above-mentioned processes for all pieces of evaluation-value computation data extracted in the evaluation period Δt is determined as a “sum of risk value relative rank for a certain sample time instant.” Performing the above-mentioned processes for all the sample time instants (t¹, t², t³, . . . , t^{K}) yields a “final sum of risk value relative rank.” Examples of the “final sum of risk value relative rank” include the sum of results obtained for all the sample time instants (t¹, t², t³, . . . , t^{K}), and the average of the results.

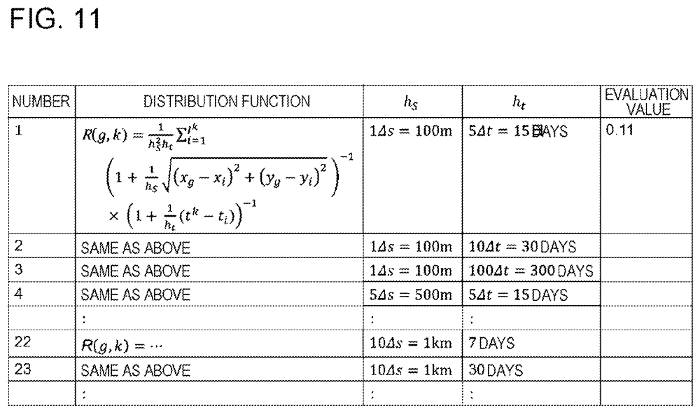

Referring back to FIG. 6, the selection unit 160 stores the coefficient of correlation CORR(hₛ, hₜ) or the sum of risk value relative rank for each combination, computed using, for example, the above-mentioned equation (6) or the above-mentioned expression (8), in a table (see, for example, FIG. 11) stored in, for example, the memory 103 as an evaluation value for each combination (S214). FIG. 11 is a diagram depicting an exemplary table that stores an evaluation value for each combination. In the example illustrated in FIG. 11, the selection unit 160 adds a coefficient of correlation “0.11” computed for the combination in the first row to the Evaluation Value column.

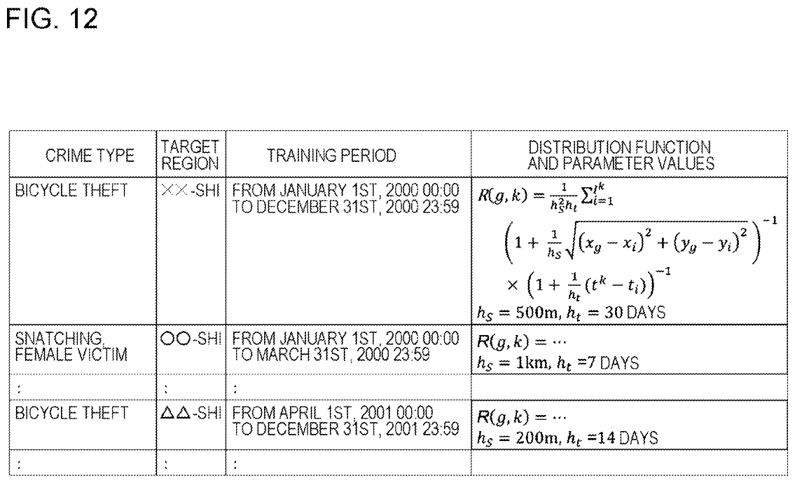

The selection unit 160 determines whether evaluation values have been computed for all combinations (S216). The selection unit 160 can determine whether evaluation values have been computed for all combinations in accordance with, for example, whether the Evaluation Value column of the table illustrated in FIG. 11 has been fully filled in. If the evaluation values have not been computed for all the combinations (NO in step S216), the process returns to step S208, in which processing for computing an evaluation value for a new combination is repeated. On the other hand, if the evaluation values have been computed for all the combinations (YES in step S216), the selection unit 160 selects a combination exhibiting a highest evaluation value and stores it in a table (see, for example, FIG. 12) for storing optimum combinations (S218). Optimum combinations of distribution functions, spatial parameters, and temporal parameters have been stored in the table illustrated in FIG. 12 in association with information representing their conditions. The selection unit 160 can use the input (for example, the crime type, the target region, and the training period) in step S202 as the information representing the conditions.

It should be noted that, although not explicitly illustrated in the table of FIG. 11, a “coefficient of correlation” and a “sum of risk value relative rank” may coexist in the Evaluation Value column. In this case, for the “coefficient of correlation” presented in equation (6), a positive value closest to one corresponds to the “highest evaluation value.” For the “sum of risk value relative rank” presented in expression (8), a smallest value corresponds to the “highest evaluation value.” When, therefore, the evaluation value of the “coefficient of correlation” and the evaluation value of the “sum of risk value relative rank” are compared with each other, no accurate result may be obtained. To avoid this problem, in adding a value to the Evaluation Value column of the table illustrated in FIG. 11, the selection unit 160 may further associate and store evaluation value type information (for example, 0=“coefficient of correlation,” and 1=“sum of risk value relative rank”) indicating whether the value corresponds to the “coefficient of correlation” or the “sum of risk value relative rank.” With this operation, the selection unit 160 can appropriately select a “combination exhibiting a highest evaluation value” by comparing evaluation values of the same type with each other.

The output unit 170 receives input of conditions regarding forecasting (for example, a crime type, a target region, a date and time of forecasting, and a forecasting period). Upon the input of the conditions regarding forecasting, the output unit 170 computes a risk distribution at a future point of time using an optimum combination of a distribution function, a spatial parameter, and a temporal parameter, selected for the conditions, and outputs it to the display device 40 or the like as a forecasting result (S220). The output unit 170 outputs, for example, a map representing the forecasting result of the risk distribution to the display device 40 or the like. The output unit 170 may even output a map representing the forecasting result of the risk distribution to a printing device (not illustrated). In this case, the map representing the forecasting result of the risk distribution is output from the printing device (not illustrated).

The details of the process in step S220 will be described below. The output unit 170 first looks up a table as illustrated in FIG. 12, based on the input conditions regarding forecasting (for example, the crime type, the target region, the date and time t^{p}, and the forecasting period Δt′), and reads a combination of a distribution function, a spatial parameter, and a temporal parameter conforming to the conditions. It should be noted that the output unit 170 preferably selects a combination allowing the “Training Period” of the table illustrated in FIG. 12 to be as close to the forecasting period Δt′ as possible. Although not particularly limited, the output unit 170 performs, for example, correction for setting the evaluation value of the combination lower as the “Training Period” of the table illustrated in FIG. 12 is farther from the start time of the forecasting period Δt′. This facilitates selection of a combination close to the forecasting period Δt′. In this case, therefore, when the function or the parameters of the risk distribution vary with time, the adverse effect of this variation can be avoided. The output unit 170 extracts data satisfying the following conditions, with regard to the input date and time t^{p}, from the crime occurrence history data stored in the history data storage unit 210. Upon defining the number of extracted pieces of data as I^{p}, the output unit 170 assigns a label i (i=1, 2, 3, . . . , I^{p}) to each of the I^{p} pieces of data.

[Math 9]

t^{p}−hₜ≤Date and Time of Ocurrence<t^{p}

and

\sqrt{(x_{g}−xᵢ)²+(y_{g}−yᵢ)²}≤hₛ (9)

The output unit 170 computes a risk value for each cell on the date and time t^{p}, using the I^{p} pieces of data and the combination of the distribution function, the spatial parameter, and the temporal parameter, read for the input conditions. When, for example, the combination in the first row of FIG. 12 is selected, a risk value R(g, p) for each cell on the date and time t^{p} is computed as the following equation (10):

$$\begin{matrix} [ Math 10 ] & \\ R ( g , p ) = \frac{1}{{h}_{s}^{2} {h}_{t}} {\sum }_{i = 1}^{{I}^{p}} {( 1 + \frac{1}{{h}_{s}} \sqrt{{( {x}_{g} - {x}_{i} )}^{2} + {( {y}_{g} - {y}_{i} )}^{2}} )}^{- 1} \times {( 1 + \frac{1}{{h}_{t}} ( {t}^{p} - {t}_{i} ) )}^{- 1} \\ {h}_{s} = 500 m , {h}_{t} = 30 Days & ( 10 )\end{matrix}$$

The output unit 170 outputs, as the forecasting result of the criminal event count, the following product of the risk value R(g, p) multiplied by the cell area Δs² of the target region and the forecasting period Δt′:

[Math 11]

NR_{g}^{p}=R(g,p)×Δs²Δt (11)

It should be noted that the processes in step S218, in which an optimum combination of a distribution function and a set of parameters involved is selected, and the preceding steps, and the process in step S220 in which a risk is forecasted using the selected combination need not always be performed successively.

As described above, in this example embodiment, a risk forecasting result is output using an optimum combination conforming to the input conditions (for example, the type of risk and the target region). Even in this example embodiment, an effect similar to that of the first example embodiment can be produced.

### Third Example Embodiment

This example embodiment has a configuration similar to that of the second example embodiment, except in the following respects.

{Functional Configuration}

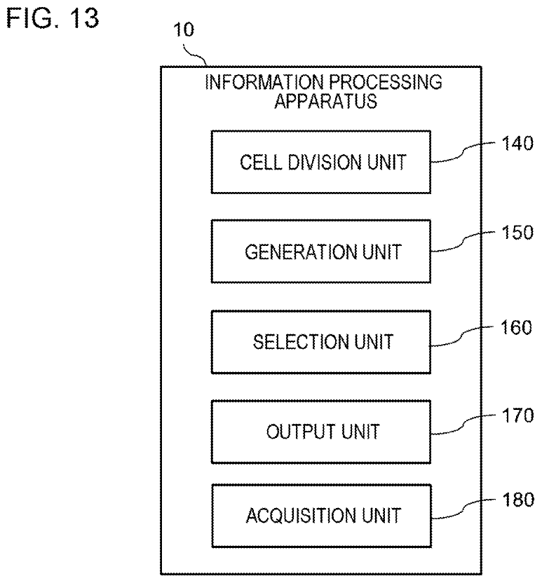

FIG. 13 is a block diagram conceptually depicting the functional configuration of an information processing apparatus 10 according to a third example embodiment. The information processing apparatus 10 according to this example embodiment further includes an acquisition unit 180, in addition to the configuration according to the second example embodiment, as illustrated in FIG. 13.

The acquisition unit 180 acquires a cell coverage ratio. The cell coverage ratio means a value representing the ratio of cells to which personnel or moving bodies can be sent to a plurality of cells divided by the cell division unit 140. The “moving bodies” include herein manned moving bodies that move while carrying personnel, such as patrol vehicles, and unmanned moving bodies such as drones.

{Hardware Configuration}

The hardware configuration according to this example embodiment is similar to that (see, for example, FIG. 2) according to the first example embodiment. The storage device 104 according to this example embodiment further stores a program module for implementing the function of the acquisition unit 180. The function of the acquisition unit 180 is implemented by the processor 102 of the information processing apparatus 10 executing the program module.

{Operation Example}

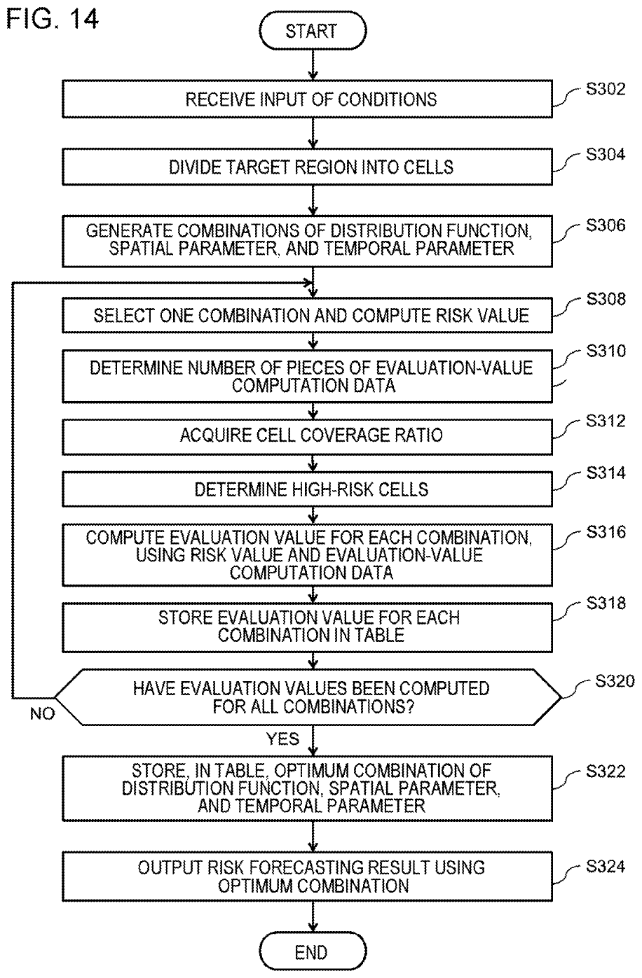

An operation example of the information processing apparatus 10 according to the third example embodiment will be described below with reference to FIG. 14. FIG. 14 is a flowchart illustrating the sequence of processing by the information processing apparatus 10 according to the third example embodiment. An example of processing, assuming a “crime” as the risk, will be given herein. Operations different from those in the second example embodiment will be mainly described herein. The processes in steps S302 to S310 of FIG. 14 are similar to those in steps S202 to 210 of FIG. 6.

The acquisition unit 180 acquires a cell coverage ratio (S312). The acquisition unit 180 can, for example, display, on the display device 40, a screen for allowing an operator to input a cell coverage ratio, and acquire the cell coverage ratio based on information input by the operator. The acquisition unit 180 passes the acquired cell coverage ratio to the selection unit 160.

The selection unit 160 determines cells (to be referred to as “high-risk cells” hereinafter), to which personnel or moving bodies are to be sent, of all the cells in the target region, based on the cell coverage ratio acquired by the acquisition unit 180, and the risk value of each cell for each sample time instant computed using the combination selected in the process of step S308 (S314). Generally, cells exhibiting relatively high risk values are preferentially determined as the high-risk cells to be patrolled by sending personnel or moving bodies. When the cell coverage ratio is %, the selection unit 160 sorts the cells of the target region in descending order of risk value for each of the sample time instants t¹, t², t³, . . . , t^{K}, determines cells (high-risk cells) corresponding to the top % for each sample time instant, and defines a set of these cells as G^{k(β)}. G^{1(β)}, for example, is a set of high-risk cells for the sample time instant tᵢ. Assume, as a specific example, that a certain target region is divided into 10,000 cells, and the cell coverage ratio acquired by the acquisition unit 180 is 1%. In this case, the selection unit 160 determines 100 cells as the high-risk cells in descending order of risk value R(g, k) for each of the sample time instants t¹, t², t³, . . . , t^{K}, and generates a set G^{k(β)} of high-risk cells using the labels g of the determined cells. For the set G^{k(β)} of high-risk cells, therefore, G^{k(β)} for one sample time instant t^{k} includes 100 cells. G^{k(β)} for all the sample time instants (t¹, t², t³, . . . , t^{K}) includes ((Number K of Sample Time Instants)×100) cells.

The selection unit 160 computes an evaluation value for each combination, based on the criminal event count of all the cells and the criminal event count of the set G^{k(β)} of high-risk cells determined in the process of step S314, for each of the sample time instants t¹, t², t³, . . . , t^{K} (S316). More specifically, the selection unit 160 computes an index (to be referred to as a “patrol coverage ratio” hereinafter) given by the following expression (12), as an evaluation value for each combination. Expression (12) exemplifies the case where the cell coverage ratio β is 1%. When, for example, the cell coverage ratio β is 10%, expression (12) takes a different value.

$$\begin{matrix}[ Math 12 ] & \\ {\sum }_{k = 1}^{K} {\sum }_{g = 1}^{{G}^{k ( β = 1 \% )}} N e v a {l}_{g}^{k} / {\sum }_{k = 1}^{K} {\sum }_{g = 1}^{G} N e v a {l}_{g}^{k} & ( 12 )\end{matrix}$$

where the numerator of the division is the sum, for all the sample time instants (t¹, t², t³, . . . , t^{K}), of the total criminal event counts of the high-risk cells for the sample time instants t^{k}, determined in the process of step S314; and the denominator of the division is the sum, for all the sample time instants (t¹, t², t³, . . . , t^{K}), of the total criminal event counts of all the cells for the sample time instants t^{k}. In other words, the selection unit 160 can compute a patrol coverage ratio for each combination by dividing the sum, for all the sample time instants (t¹, t², t³, . . . , t^{K}), of the numbers of criminal events that have occurred in the high-risk cells (that is, the cells to be patrolled) among all crimes that have occurred in evaluation periods Δt of certain sample time instants t^{k} by the sum, for all the sample time instants (t¹, t², t³, . . . , t^{K}), of the numbers of criminal events in all the cells that have occurred in the evaluation periods Δt of the certain sample time instants t^{k}.

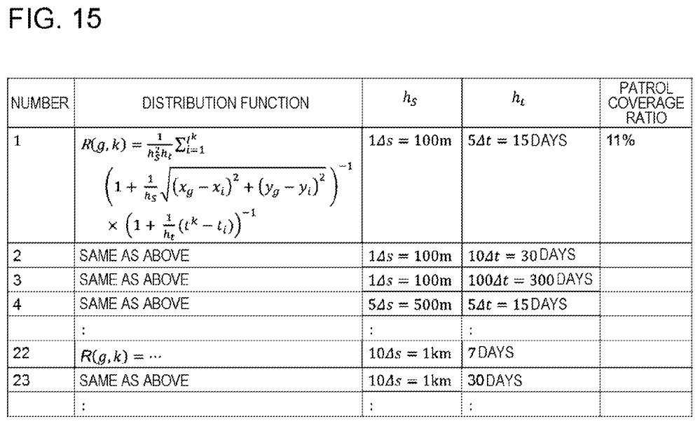

The selection unit 160 stores the patrol coverage ratio for each combination, computed using, for example, the above-mentioned expression (12), in a table (see, for example, FIG. 15) stored in, for example, the memory 103 as an evaluation value for each combination (S318). FIG. 15 is a diagram depicting an exemplary table that stores an evaluation value for each combination. In the example illustrated in FIG. 15, the selection unit 160 adds a patrol coverage ratio “11%” computed for the combination in the first row to the Evaluation Value column.

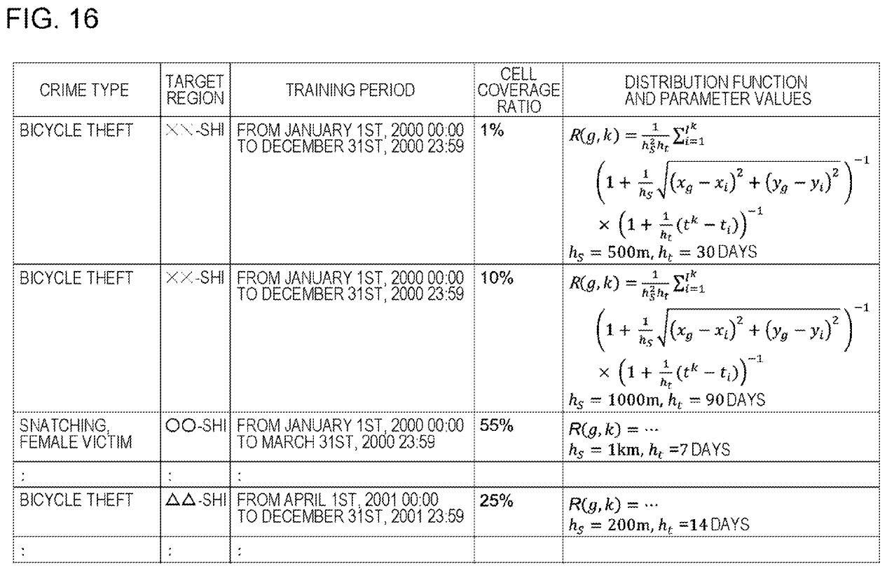

The selection unit 160 determines whether evaluation values have been computed for all combinations (S320). The selection unit 160 can determine whether evaluation values have been computed for all combinations in accordance with, for example, whether the Evaluation Value column of the table illustrated in FIG. 15 has been fully filled in. If the evaluation values have not been computed for all the combinations (NO in step S320), the process returns to step S308, in which processing for computing an evaluation value for a new combination is repeated. On the other hand, if the evaluation values have been computed for all the combinations (YES in step S320), the selection unit 160 selects a combination exhibiting a highest evaluation value and stores it in a table (see, for example, FIG. 16) for storing optimum combinations (S322). Optimum combinations of distribution functions, spatial parameters, and temporal parameters have been stored in the table illustrated in FIG. 16 in association with information representing their conditions. The selection unit 160 can use the input (for example, the crime type, the target region, and the training period) in step S302 and the cell coverage ratio acquired in step S312, as the information representing the conditions.

The output unit 170 receives input of conditions regarding forecasting (for example, a crime type, a target region, a date and time of forecasting, a forecasting period, and a cell coverage ratio). Upon the input of the conditions regarding forecasting, the output unit 170 computes a risk distribution at a future point of time using a combination of a distribution function, a spatial parameter, and a temporal parameter, selected for the conditions, and outputs it to the display device 40 or the like as a forecasting result (S324). The output unit 170 outputs, for example, a map representing the forecasting result of the risk distribution to the display device 40 or the like. The output unit 170 may even output a map representing the forecasting result of the risk distribution to a printing device (not illustrated). In this case, the map representing the forecasting result of the risk distribution is output from the printing device (not illustrated).

The details of the process in step S324 will be described below. The output unit 170 first looks up a table as illustrated in FIG. 16, based on the input conditions regarding forecasting (for example, the crime type, the target region, the date and time t^{p}, the forecasting period Δt′, and the cell coverage ratio), and reads a combination of a distribution function, a spatial parameter, and a temporal parameter conforming to the conditions. The cell coverage ratio acts herein as a factor that influences the evaluation value used in selecting an “optimum combination,” as presented in, for example, the above-mentioned expression (12). Thus, when the cell coverage ratio input as a forecasting condition differs, the optimum combination of the distribution function, the spatial parameter, and the temporal parameter is expected to differ as well. The output unit 170 selects, as a combination used to forecast a risk distribution, a combination having a cell coverage ratio as close to that input as a forecasting condition as possible from the table illustrated in, for example, FIG. 16. The output unit 170 can select, for example, a combination allowing the absolute value of the difference in cell coverage ratio to be equal to or smaller than a predetermined threshold. Assume, as a specific example, that the crime type is bicycle theft, and xx City of the target region is divided into 10,000 cells. The cell coverage ratio set as a condition regarding forecasting is assumed to be 1.5%. This means that personnel or moving bodies can be sent to 150 cells of the cells in the xx City of the target region. The above-mentioned predetermined threshold is assumed to be 1%. In this case, combinations of distribution functions, spatial parameters, and temporal parameters conforming to the conditions regarding forecasting (the crime type and the target region) are present in the first and second rows of the table illustrated in FIG. 16. It should be noted that, since the cell coverage ratio is 1% in the first row and 10% in the second row, both cell coverage ratios are different from the cell coverage ratio of 1.5% set as a condition regarding forecasting. However, the absolute value of the difference between the cell coverage ratio of 1% in the first row and the cell coverage ratio of 1.5% set as a condition regarding forecasting is equal to or smaller than the predetermined threshold (1%). Therefore, the output unit 170 can select the combination in the first row as a combination used to forecast a risk distribution. When any pertinent combination is absent in the table illustrated in FIG. 16, the selection unit 160 may update the table by performing the processes in steps S314 to S322, using the cell coverage ratio input as a forecasting condition. The output unit 170 can then read a combination conforming to the conditions regarding forecasting from the updated table.

The subsequent processes are similar to those in the second example embodiment. More specifically, the output unit 170 extracts data satisfying the conditions presented in set of inequalities (9), with regard to the input date and time t^{P}, from the crime occurrence history data stored in the history data storage unit 210. Upon defining the number of extracted pieces of data as I^{p}, the output unit 170 assigns a label i (i=1, 2, 3, . . . , I^{p}) to each of the I^{p} pieces of data. The output unit 170 computes a risk value R(g, p) for each cell on the date and time t^{p}, using the I^{p} pieces of data and the combination of the distribution function, the spatial parameter, and the temporal parameter, read for the input conditions. When, for example, the combination in the first row of FIG. 16 is selected, a risk value R(g, p) for each cell on the date and time t^{p} is computed using equation (10). The output unit 170 outputs, as the forecasting result of the criminal event count, the product of the risk value R(g, p) multiplied by the cell area Δs² of the target region and the forecasting period Δt′, as presented in equation (11).

As described above, according to this example embodiment, an effect similar to those of the above-described example embodiments can be produced. In this example embodiment, furthermore, high-risk cells (cells to be patrolled) are determined based on the cell coverage ratio (the ratio of cells that can be patrolled) and the risk value of each cell computed using the combination of the distribution function and the set of parameters involved. The ratio of the criminal event count of the high-risk cells to the criminal event count of all the cells is used as an evaluation value for each combination. An “optimum combination” is selected based on the thus computed evaluation values, and stored in a predetermined storage unit together with the “cell coverage ratio.” With this operation, when cells to which personnel or equipment and materials can be sent in the target region are limited, accurate forecasting can be performed by selecting an optimum combination of a distribution function, a spatial parameter, and a temporal parameter that depends on the ratio of the cells (cell coverage ratio).

Example embodiments of the present invention have been described above with reference to the drawings, but they are merely illustrative examples of the present invention, and can adopt various configurations other than the foregoing.

For example, in each of the above-described example embodiments, information for determining cell types may further be acquired, and an optimum combination of a distribution function, a spatial parameter, and a temporal parameter may be selected for each of the acquired cell types. Examples of the cell types include herein land use types in National Land Numerical Information provided by the Ministry of Land, Infrastructure, Transport and Tourism. When the cell coverage ratio according to the third example embodiment is used, the following processing, for example, can further be performed. The cell division unit 140 first determines whether the land use type corresponding to each cell applies to a type to be patrolled (for example, “building land”) by referring to the National Land Numerical Information, and assigns a predetermined flag to cells of the type to be patrolled. The selection unit 160 determines high-risk cells of the cells assigned with the predetermined flag, and computes a patrol coverage ratio based on the criminal event count in the high-risk cells. This makes it possible to select an optimum combination that maximizes the forecasting accuracy rate in cells of a desired type, such as “building land.” This implementation is useful in the cases where specific locations are to be monitored, such as a case where a plan for patrolling a residential area is devised. It should be noted that even in the second example embodiment, the selection unit 160 can compute a coefficient of correlation or a sum of risk value relative rank for cells corresponding to a desired cell type.

In the second and third example embodiments, an example in which a table (see, for example, FIGS. 11 and 15) for storing an evaluation value for each combination is generated has been given, but the selection unit 160 may hold these pieces of information instead of generating such a table.

In the plurality of flowcharts referred to in the above description, a plurality of steps (processes) have been set forth in order, but the order of execution of the steps executed in each example embodiment is not limited to the order set forth. In each example embodiment, the order of the steps illustrated in the drawing can be changed unless any technical difficulties are encountered. The above-described example embodiments can be combined with each other unless any technical contradiction arises between them.

Part or all of the above-described example embodiments may be described as in the following supplementary notes, but they are not limited thereto.

1.

An information processing apparatus including:

a data division unit that divides risk occurrence history data of a target region into training data used for computing a risk value for each of combinations of a distribution function spatially and temporally representing a risk distribution in the target region, a spatial parameter of the distribution function, and a temporal parameter of the distribution function, and evaluation-value computation data used for evaluating a combination of the distribution function, the spatial parameter, and the temporal parameter;

a selection unit that selects one combination from among combinations of the distribution function, the spatial parameter, and the temporal parameter, based on an evaluation value for each of the combinations computed based on a risk value for each of the combinations based on the training data and the evaluation-value computation data; and

an output unit that outputs a risk forecasting result of the target region, by using the one combination selected by the selection unit.

2.

An information processing apparatus including:

a cell division unit that divides a target region into a plurality of cells;

a generation unit that generates a plurality of combinations of a distribution function spatially and temporally representing a risk distribution in the target region, a spatial parameter of the distribution function, and a temporal parameter of the distribution function;

a selection unit that computes an evaluation value for each of the combinations, by using risk occurrence history data for each of the cells from among risk occurrence history data of the target region, and selecting one combination from among the plurality of combinations, based on the evaluation value for the each combination; and

an output unit that outputs a risk forecasting result of the target region, by using the one combination selected by the selection unit.

3.

The information processing apparatus according to 2, further including:

an acquisition unit that acquires a cell coverage ratio representing a ratio of cells to which personnel or a moving body can be sent, to the plurality of cells,

in which the selection unit computes the evaluation value, based on the cell coverage ratio.

4.

The information processing apparatus according to 3, in which the output unit determines a combination to be used for generating the risk forecasting result, based on a second cell coverage ratio input independently of the cell coverage ratio and set as a forecasting condition.

5.

The information processing apparatus according to 2, in which the selection unit computes, as the evaluation value, a coefficient of correlation computed, based on a risk value for each combination of the distribution function, the spatial parameter, and the temporal parameter, and a risk occurrence count based on the risk occurrence history data.

6.

The information processing apparatus according to 2, in which the selection unit computes, as the evaluation value, a sum of risk value relative rank computed, based on a risk value for each combination of the distribution function, the spatial parameter, and the temporal parameter, and a risk occurrence count based on the risk occurrence history data.

7.

The information processing apparatus according to any one of 2 to 6, in which the generation unit sets a plurality of sample time instants in a specified period, and computes the evaluation value for each of the combinations, by using risk values computed based on the combinations and data in a predetermined time before the sample time instants among the risk occurrence history data, and data within a predetermined time after the sample time instants among the risk occurrence history data.

8.

The information processing apparatus according to any one of 1 to 7, further including:

a reception unit that receives input for specifying a type of risk,

in which the selection unit selects data related to the type of risk specified by the input for specifying, from among the risk occurrence history data of the target region.

9.

A risk forecasting method executed by a computer, the method including:

dividing risk occurrence history data of a target region into training data used for computing a risk value for each of combinations of a distribution function spatially and temporally representing a risk distribution in the target region, a spatial parameter of the distribution function, and a temporal parameter of the distribution function, and evaluation-value computation data used for evaluating a combination of the distribution function, the spatial parameter, and the temporal parameter;

selecting one combination from among combinations of the distribution function, the spatial parameter, and the temporal parameter, based on an evaluation value for each of the combinations computed based on a risk value for each of the combinations based on the training data and the evaluation-value computation data; and

outputting a risk forecasting result of the target region, by using the selected one combination.

10.

A risk forecasting method executed by a computer, the method including:

dividing a target region into a plurality of cells;

generating a plurality of combinations of a distribution function spatially and temporally representing a risk distribution in the target region, a spatial parameter of the distribution function, and a temporal parameter of the distribution function;

computing an evaluation value for each of the combinations, by using risk occurrence history data for each of the cells from among risk occurrence history data of the target region, and selecting one combination from among the plurality of combinations, based on the evaluation value for the each combination; and

outputting a risk forecasting result of the target region, by using the selected one combination.

11.

The risk forecasting method executed by a computer according to 10, the method further including:

acquiring a cell coverage ratio representing a ratio of cells to which personnel or a moving body can be sent, to the plurality of cells; and

computing the evaluation value, based on the cell coverage ratio.

12.

The risk forecasting method executed by a computer according to 11, the method further including:

determining a combination used for generating the risk forecasting result, based on a second cell coverage ratio input independently of the cell coverage ratio and set as a forecasting condition.

13.

The risk forecasting method executed by a computer according to 10, the method further including:

computing, as the evaluation value, a coefficient of correlation computed based on a risk value for each of combinations of the distribution function, the spatial parameter, and the temporal parameter, and a risk occurrence count based on the risk occurrence history data.

14.

The risk forecasting method executed by a computer according to 10, the method further including:

computing, as the evaluation value, a sum of risk value relative rank computed, based on a risk value for each of combinations of the distribution function, the spatial parameter, and the temporal parameter, and a risk occurrence count based on the risk occurrence history data.

15.

The risk forecasting method executed by a computer according to any one of 10 to 14, the method further including:

setting a plurality of sample time instants in a specified period, and computing the evaluation value for each of the combinations, by using risk values computed based on the combinations and data in a predetermined time before the sample time instants among the risk occurrence history data, and data within a predetermined time after the sample time instants among the risk occurrence history data.

16.

The risk forecasting method executed by a computer according to any one of 9 to 15, the method further including:

receiving input for specifying a type of risk; and

selecting data related to the type of risk specified by the input for specifying, from among the risk occurrence history data of the target region.

17.

A program for causing a computer to execute the risk forecasting method according to any one of supplementary notes 9 to 16.

This application is based upon and claims the benefit of priority from Japanese Patent Application No. 2017-202195 filed on Oct. 18, 2017, the disclosure of which is incorporated herein in its entirety by reference.

1. An information processing apparatus comprising:
a data division unit that divides risk occurrence history data of a target region into training data used for computing a risk value for each of combinations of a distribution function spatially and temporally representing a risk distribution in the target region, a spatial parameter of the distribution function, and a temporal parameter of the distribution function, and evaluation-value computation data used for evaluating a combination of the distribution function, the spatial parameter, and the temporal parameter;
a selection unit that selects one combination from among combinations of the distribution function, the spatial parameter, and the temporal parameter, based on an evaluation value for each of the combinations computed based on a risk value for each of the combinations based on the training data and the evaluation-value computation data; and
an output unit that outputs a risk forecasting result of the target region, by using the one combination selected by the selection unit.

2. An information processing apparatus comprising:
a cell division unit that divides a target region into a plurality of cells;
a generation unit that generates a plurality of combinations of a distribution function spatially and temporally representing a risk distribution in the target region, a spatial parameter of the distribution function, and a temporal parameter of the distribution function;
a selection unit that computes an evaluation value for each of the combinations, by using risk occurrence history data for each of the cells from among risk occurrence history data of the target region, and selecting one combination from among the plurality of combinations, based on the evaluation value for the each combination; and
an output unit that outputs a risk forecasting result of the target region, by using the one combination selected by the selection unit.

3. The information processing apparatus according to claim 2, further comprising:
an acquisition unit that acquires a cell coverage ratio representing a ratio of cells to which personnel or a moving body can be sent, to the plurality of cells,
wherein the selection unit computes the evaluation value, based on the cell coverage ratio.

4. The information processing apparatus according to claim 3, wherein the output unit determines a combination to be used for generating the risk forecasting result, based on a second cell coverage ratio input independently of the cell coverage ratio and set as a forecasting condition.

5. The information processing apparatus according to claim 2, wherein the selection unit computes, as the evaluation value, a coefficient of correlation computed, based on a risk value for each combination of the distribution function, the spatial parameter, and the temporal parameter, and a risk occurrence count based on the risk occurrence history data.

6. The information processing apparatus according to claim 2, wherein the selection unit computes, as the evaluation value, a sum of risk value relative rank computed, based on a risk value for each combination of the distribution function, the spatial parameter, and the temporal parameter, and a risk occurrence count based on the risk occurrence history data.

7. The information processing apparatus according to claim 2, wherein the generation unit sets a plurality of sample time instants in a specified period, and computes the evaluation value for each of the combinations, by using risk values computed based on the combinations and data in a predetermined time before the sample time instants among the risk occurrence history data, and data within a predetermined time after the sample time instants among the risk occurrence history data.

8. The information processing apparatus according to claim 1, further comprising:
a reception unit that receives input for specifying a type of risk,
wherein the selection unit selects data related to the type of risk specified by the input for specifying, from among the risk occurrence history data of the target region.

9. A risk forecasting method executed by a computer, the method comprising:
dividing risk occurrence history data of a target region into training data used for computing a risk value for each of combinations of a distribution function spatially and temporally representing a risk distribution in the target region, a spatial parameter of the distribution function, and a temporal parameter of the distribution function, and evaluation-value computation data used for evaluating a combination of the distribution function, the spatial parameter, and the temporal parameter;
selecting one combination from among combinations of the distribution function, the spatial parameter, and the temporal parameter, based on an evaluation value for each of the combinations computed based on a risk value for each of the combinations based on the training data and the evaluation-value computation data; and
outputting a risk forecasting result of the target region, by using the selected one combination.

10. A risk forecasting method executed by a computer, the method comprising:
dividing a target region into a plurality of cells;
generating a plurality of combinations of a distribution function spatially and temporally representing a risk distribution in the target region, a spatial parameter of the distribution function, and a temporal parameter of the distribution function;
computing an evaluation value for each of the combinations, by using risk occurrence history data for each of the cells from among risk occurrence history data of the target region, and selecting one combination from among the plurality of combinations, based on the evaluation value for the each combination; and
outputting a risk forecasting result of the target region, by using the selected one combination.

11. The risk forecasting method executed by a computer according to claim 10, the method further comprising:
acquiring a cell coverage ratio representing a ratio of cells to which personnel or a moving body can be sent, to the plurality of cells; and
computing the evaluation value, based on the cell coverage ratio.

12. The risk forecasting method executed by a computer according to claim 11, the method further comprising:
determining a combination used for generating the risk forecasting result, based on a second cell coverage ratio input independently of the cell coverage ratio and set as a forecasting condition.

13. The risk forecasting method executed by a computer according to claim 10, the method further comprising:
computing, as the evaluation value, a coefficient of correlation computed based on a risk value for each combination of the distribution function, the spatial parameter, and the temporal parameter, and a risk occurrence count based on the risk occurrence history data.

14. The risk forecasting method executed by a computer according to claim 10, the method further comprising:
computing, as the evaluation value, a sum of risk value relative rank computed, based on a risk value for each combination of the distribution function, the spatial parameter, and the temporal parameter, and a risk occurrence count based on the risk occurrence history data.

15. The risk forecasting method executed by a computer according to claim 10, the method further comprising:
setting a plurality of sample time instants in a specified period, and computing the evaluation value for each of the combinations, by using risk values computed based on the combinations and data in a predetermined time before the sample time instants among the risk occurrence history data, and data within a predetermined time after the sample time instants among the risk occurrence history data.

16. The risk forecasting method executed by a computer according to claim 9, the method further comprising:
receiving input for specifying a type of risk; and
selecting data related to the type of risk specified by the input for specifying, from among the risk occurrence history data of the target region.

17. A non-transitory computer readable medium storing a program for causing a computer to execute a risk forecasting method, the method comprising:
dividing risk occurrence history data of a target region into training data used for computing a risk value for each of combinations of a distribution function spatially and temporally representing a risk distribution in the target region, a spatial parameter of the distribution function, and a temporal parameter of the distribution function, and evaluation-value computation data used for evaluating a combination of the distribution function, the spatial parameter, and the temporal parameter;
selecting one combination from among combinations of the distribution function, the spatial parameter, and the temporal parameter, based on an evaluation value for each of the combinations computed based on a risk value for each of the combinations based on the training data and the evaluation-value computation data; and
outputting a risk forecasting result of the target region, by using the selected one combination.

18. A non-transitory computer readable medium storing a program for causing a computer to execute a risk forecasting method, the method comprising:
dividing a target region into a plurality of cells;
generating a plurality of combinations of a distribution function spatially and temporally representing a risk distribution in the target region, a spatial parameter of the distribution function, and a temporal parameter of the distribution function;
computing an evaluation value for each of the combinations, by using risk occurrence history data for each of the cells from among risk occurrence history data of the target region, and selecting one combination from among the plurality of combinations, based on the evaluation value for the each combination; and
outputting a risk forecasting result of the target region, by using the selected one combination.
